(19) United States
(12) Patent Application Publication
(10) Pub. No.: US 2020/0210999 A1
(43) Pub. Date: Jul. 2, 2020

(54) System and Method for Settling a Payment Transaction Using Multiple Electronic Currencies

(71) Applicant: Multichain Ventures, Inc., Las Vegas, NV (US)

(72) Inventor: Michael Wagner, Las Vegas, NV (US)

(73) Assignee: Multichain Ventures, Inc., Las Vegas, NV (US)

(21) Appl. No.: 16/729,048

(22) Filed: Dec. 27, 2019

Related U.S. Application Data
(60) Provisional application No. 62/785,323, filed on Dec. 27, 2018.

(51) Int. Cl. G06Q 20/38; G06Q 20/40; G06Q 20/32; G06Q 20/20

(52) U.S. Cl. CPC G06Q 20/381; G06Q 20/20; G06Q 20/3221; G06Q 20/405

(57) ABSTRACT

A system and method for converting electronic currencies may be implemented in a trade engine module on a mobile device. A merchant external wallet address is received from a merchant for assets of the merchant that have a respective value in an associated currency. The merchant can define allocation of payments to the merchant among the assets. Orders received from the merchant represent a transaction value in a fiat currency. The transaction value is divided into a plurality of allocations based on the allocation specified by the merchant. A conversion rate between the fiat currency and the currency of the asset associated with the allocation for each of the allocations is determined. Each of the allocations are converted from the fiat currency to the currency of the asset associated with the allocation based on the conversion rate.

### CROSS-REFERENCE TO RELATED APPLICATIONS

This application claims the benefit of and priority to U.S. Provisional Patent Application No. 62/785,323 filed in the U.S. Patent Office on Dec. 27, 2018 entitled “System and Method for Settling a Payment Transaction Using Multiple Electronic Currencies”, the entirety of which is incorporated herein by reference.

### FIELD OF TECHNOLOGY

The present application pertains to technologies for settling transactions in virtual currencies.

### BACKGROUND

Virtual currencies including cryptocurrencies such as bitcoin, and numerous other decentralized block-chain technologies have enormous potential as a means of exchanging value. These technologies can be implemented to facilitate direct transactions between customers and merchants without involving intervening financial institutions. However, cryptocurrencies are not yet widely accepted by retail merchants.

Transactions using virtual currencies have heretofore been more time consuming and cumbersome than transactions using traditional currencies. Moreover, exchange rates between various cryptocurrencies and between cryptocurrencies and traditional currencies tend to be more volatile than exchange rates between traditional currencies. These factors detract from the widespread adoption of cryptocurrencies for customer-merchant transactions.

### SUMMARY

Aspects of the present disclosure include a mobile device apparatus, system and method for settling a point of sale transaction involving a plurality of currencies between a customer and a merchant. The disclosed system and apparatus which includes a processor in communication with a memory and in communication with a user interface. A trade engine module stored in the memory and executable by the processor is configured to facilitate trading in the plurality of electronic currencies.

The disclosed trade engine module may implement a pricing model that queries prices of goods generated from multiple exchanges and also takes into account current liquidity of exchanges on both sides of an order book

The disclosed system facilitates transaction settlement of value to the merchant in the merchant's own pre designated preferred crypto or fiat equivalent denomination, or combinations thereof, even though the merchant's preferred cryptocurrency may involve completely different settlement processing steps than another cryptocurrency remitted by a customer.

### BRIEF DESCRIPTION OF THE DRAWINGS

The disclosed apparatus, system and method is described below in more detail with reference to embodiments shown in the figures.

FIG. 1 is a system block diagram of a mobile device apparatus according to an illustrative embodiment of the present disclosure; and

FIG. 2 is a process flow diagram of a method for converting electronic currencies according to an illustrative embodiment of the present disclosure.

### DETAILED DESCRIPTION

Aspects of the present disclosure include a method of settling a payment transaction between a customer and a merchant via a payment service. The payment transaction may be a point of sale transaction or an e-commerce transaction, for example. The method includes receiving by the payment service from a merchant, a respective identification of a merchant external wallet address for each of one or more assets of the merchant, wherein each of the assets comprises a respective value in an associated currency. In this step, the merchant notifies the payment service of its money accounts and/or crypto currency accounts. Next, the method includes receiving by the payment service from the merchant, an allocation specification on defining a division of payments to the merchant among the one or more assets. In this step, the merchant specifies how his payments should be divided among his accounts.

According to an aspect of the present disclosure, the method also includes receiving by the payment service an order from the merchant, the order defining a transaction value in a fiat currency. In an illustrative embodiment, the fiat currency is U.S. dollars. In an alternative embodiment, a different fiat currency may be used, or a fiat currency may be selected by the merchant, for example.

Next, the method includes dividing the transaction value into a plurality of allocations based on the allocation specification. For each of the allocations, the method includes determining a conversion rate between the fiat currency and the currency of the asset associated with the allocation.

In an illustrative embodiment, the conversion rate is computed by looking at open market order books on various crypto exchanges. In doing so, a weighted average price is computed based on the volume of liquidity on the buy side (i.e., when a received asset is to be sold), or sell side (i.e., when an alternative asset is to be bought).

For example, in the illustrative embodiment, a U.S. dollar price is delivered based on items in a ‘shopping cart’. The merchant is actually going to accept bitcoin (BTC) as currency on this transaction, BTC (buy side) order books are consulted to determine how many bitcoin would need to be sold to arrive at the exact dollar value. That amount is presented to a customer and remitted. If the merchant wants to further diversify this into their predetermined basket of currencies, the BTC received are used to buy from existing sell orders the dollar value of the desired alternative currencies. If the merchant desires a stable asset the payment service sells into the bitcoin buy side order book and uses the proceeds to buy a dollar-pegged asset.

In an illustrative embodiment, the disclosed method also includes converting each of the allocations from the fiat currency to the currency of the asset associated with the allocation, based on the conversion rate. The method further includes notifying the merchant of the value of each allocation in the currency of the asset associated with the corresponding allocation.

The disclosed method may also include receiving the transaction value from the merchant in the fiat currency. In response to receiving the transaction value, the method includes providing to the merchant the value of each allocation in the currency of the asset associated with the corresponding allocation

The payment services uses the fiat currency as a reference rate. For example, the payment system delivers a dollar equivalent asset that is a digital currency pegged to and backed by one USD for every one unit of digital currency. This method retains a digitized asset while reducing or eliminating volatility.

In an illustrative embodiment, the step of converting each of the allocations from the fiat currency to the currency of the asset associated with the allocation includes computing a volume weighted average price of the currency of the asset across a plurality of public exchanges of the currency of the asset. The volume weighted average price may be based on visible market liquidity of the currency of the asset, for example.

According to another aspect of the present disclosure, the step of converting each of the allocations from the fiat currency to the currency of the asset associated with the allocation includes querying a current price in the currency of the asset versus the fiat currency on both sides of a plurality of currency exchanges, wherein the currency exchanges may be centralized exchange operations or decentralized centralized exchange operations, for example.

According to another aspect of the present disclosure, the step of converting each of the allocations from the fiat currency to the currency of the asset associated with the allocation may include determining liquidity of the currency of the asset on one or more currency exchanges, for example.

Aspects of the present disclosure also include an apparatus for settling a point of sale transaction involving a plurality of currencies between a customer and a merchant. The apparatus includes a mobile device comprising a processor in communication with a memory and in communication with a user interface, and a trade engine module in the memory and executable by the processor. The trade engine module is configured to receive from the merchant, a respective identification of a merchant external wallet address for each of one or more assets of the merchant, wherein each of the assets comprises a respective value in an associated currency. The trade engine receives from the merchant, an allocation specification on defining a division of payments to the merchant among the one or more assets and receives an order from the merchant. The order defines a transaction value in a fiat currency.

According to an aspect of the present disclosure, the trade engine module is further configured to divide the transaction value into a plurality of allocations based on the allocation specification. For each of the allocations the trade engine module determines a conversion rate between the fiat currency and the currency of the asset associated with the allocation. The trade engine module is configured to convert each of the allocations from the fiat currency to the currency of the asset associated with the allocation, based on the conversion rate. The trade engine module then notifies the merchant of the value of each allocation in the currency of the asset associated with the corresponding allocation.

According to an aspect of the present disclosure the trade engine is further configured to transmit the transaction value from the merchant to a payment service in one or more electronic currencies referenced to the fiat currency, and in response to receiving the transaction value, receive from the payment service to the merchant the value of each allocation in the currency of the asset associated with the corresponding allocation.

In an illustrative embodiment, the trade engine module converts each of the allocations from the fiat currency to the currency of the asset associated with the allocation by computing a volume weighted average price of the currency of the asset across one or more public exchanges of the currency of the asset. The volume weighted average price is based on visible market liquidity of the currency of the asset.

According to an aspect of the present disclosure, the trade engine module converts each of the allocations from the fiat currency to the currency of the asset associated with the allocation by querying a current price in the currency of the asset versus the fiat currency on both sides of one or more currency exchanges. Again, it should be understood that the currency exchanges may be centralized exchange operations, which may be hosted by a single entity in which users can join together to facilitate an exchange process, and/or decentralized exchange operations wherein the exchange process may be facilitated by a decentralized technology protocol, for example.

The conversion of each of the allocations from the fiat currency to the currency of the asset associated with the allocation includes determining liquidity of the currency of the asset on a plurality of currency exchanges, wherein the currency exchanges are either centralized exchange operations or decentralized centralized exchange operations.

An outline of illustrative embodiments of the disclosed system and method is provided below in Table 1.

TABLE 1

| 1. | Point of Sale - Merchant Specifications | |
|---|---|---|
| | a. | Merchant specifies external wallet address for payments |
| | | to be sent, per asset, within the software |

| | |
|---|---|
| i. | Assets may be externally and directly custodied by |
| | merchant itself or the merchant may deliver assets |
| | to a third party entity such as a custodian and/or |
| | compliance agent. The third party entity may secure |
| | and/or insure the assets for example. |

| | b. | Merchant also specifies desired ‘allocation’ of assets for |
|---|---|---|
| | | every sale - to be further defined below |
| 2. | Price conversion of USD to an array of digital currency assets | |
| | a. | An order is generated (within POS) based in $USD, which is |
| | | then converted to a chargeable amount in an array of selectable |
| | | digital currency assets (i.e. $tks, $btc, $1tc, $eth, etc.) |
| | b. | Price conversion includes a VWAP (volume weighted average |
| | | price) based on visible market liquidity across public exchanges, |
| | | ensuring best execution is received for converted assets |
| | c. | To summarize, the merchant frames a sale in USD, but wishes to |
| | | accept digital currency, and the disclosed system and method |
| | | informs the merchant of the appropriate amount of that digital |
| | | asset to accept |
| 3. | Portfolio Allocation | |
| | a. | Merchant is provided the ability to receive any crypto asset |
| | | and have that programmatically (automatically) converted into |
| | | their desired digital currency exposure, which is defined in |
| | | their settings panel |
| | b. | For example, accept $BTC, convert to 20% $TKS, 20% $LTC, |
| | | and 60% $ETH |
| 4. | Trade Processing | |
| | a. | Coupled with the specified portfolio allocation above, a trade |
| | | engine is built into the software |
| | b. | Again, using market liquidity and best execution, an internal |
| | | liquidity pool on various public crypto exchanges is utilized |
| | | to process trades and create an asset basket to meet allocation |
| | | requirements |
| | c. | Programmatically merchant delivers to payment service the |
| | | received asset and the payment services returns back to them |
| | | their desired portfolio |
| 5. | Optional embodiments | |
| | a. | All payments may be processed via QR barcode |
| | b. | Payments may be facilitated at least partially with a mobile |
| | | consumer wallet (app), although consumers can use other QR |
| | | capable mobile wallets depending on the digital currency asset |
| | | they're spending |

The processing flow of the disclosed merchant gateway method is directed to the MERCHANT side of payment transactions.

Aspects of the present disclosure include a pricing model that queries U.S. dollar and crypto-currency transaction prices of goods generated from multiple exchanges and also takes into account liquidity currently existing on those exchanges on both sides of the order book.

Settlement TO the merchant is provided in the merchant's own pre designated preferred crypto or fiat equivalent denomination.

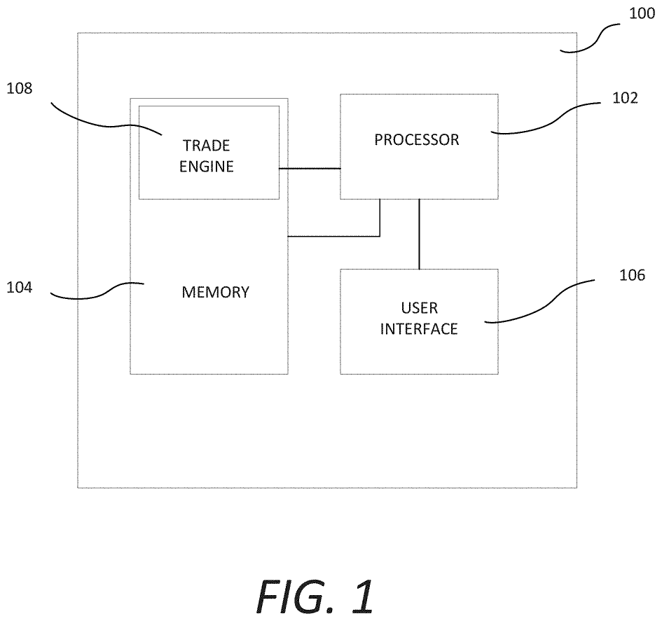

An apparatus for settling a point of sale transaction involving one or more currencies between a customer and a merchant according to an aspect of the present disclosure is described with reference to FIG. 1. According to this aspect, a mobile device 100 includes a processor 102 in communication with a memory 104 and in communication with a user interface 106. The mobile device 100 also includes a trade engine module 108 in the memory 104 and executable by the processor 104. The trade engine 108 module is configured to receive from the merchant, a respective identification of a merchant external wallet address for each of one or more assets of the merchant, wherein each of the assets comprises a respective value in an associated currency. The trade engine module 108 is further configured to receive from the merchant, an allocation specification on defining a division of payments to the merchant among the one or more assets. The trade engine module 108 is further configured to receive an order from the merchant, wherein the order defines a transaction value in a fiat currency. The trade engine module 108 is further configured to then divide the transaction value into a plurality of allocations based on the allocation specification. The trade engine module 108 is configured to determine, for each of the allocations, a conversion rate between the fiat currency and the currency of the asset associated with the allocation. The trade engine module 108 is configured to then convert each of the allocations from the fiat currency to the currency of the asset associated with the allocation based on the conversion rate. The trade engine module 108 is configured to notify the merchant, via the user interface 106, for example, of the value of each allocation in the currency of the asset associated with the corresponding allocation.

According to another aspect of the present disclosure, the trade engine module 108 may be further configured to transmit the transaction value from the merchant to a payment service in one or more electronic currencies referenced to the fiat currency. In response to receiving the transaction value, the trade engine module may receive from the payment service to the merchant the value of each allocation in the currency of the asset associated with the corresponding allocation.

Converting each of the allocations from the fiat currency to the currency of the asset associated with the allocation may be performed by computing a volume weighted average price of the currency of the asset across a plurality of public exchanges of the currency of the asset, for example. The volume weighted average price may be based on visible market liquidity of the currency of the asset, for example.

According to another aspect of the present disclosure, the process of converting each of the allocations from the fiat currency to the currency of the asset associated with the allocation by the trade engine module 108 may include querying a current price in the currency of the asset versus the fiat currency on both sides of a plurality of currency exchanges.

According to another aspect of the present disclosure, the process of converting each of the allocations from the fiat currency to the currency of the asset associated with the allocation by the trade engine module 108 may include determining liquidity of the currency of the asset on one or more currency exchanges, for example.

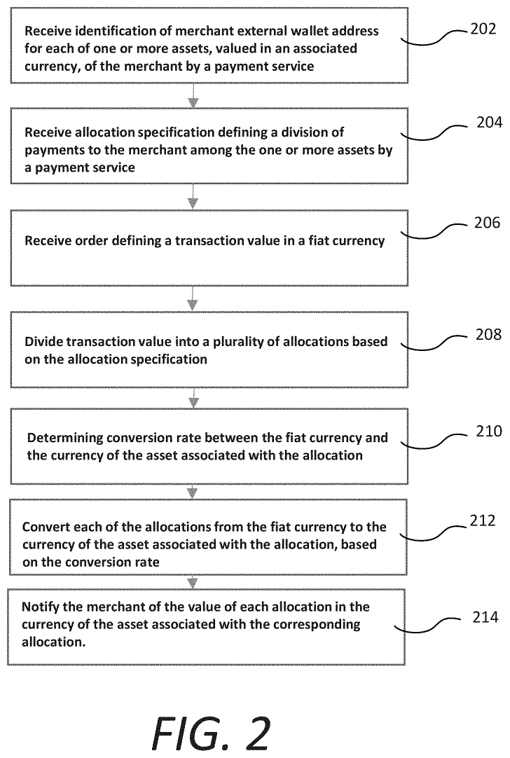

FIG. 2 is a system block diagram illustrating a method 200 for converting electronic currencies that may be implemented in the trade engine module 108 of a mobile device 100 according to an aspect of the present disclosure. At step 202, the method includes receiving a respective identification of a merchant external wallet address from a merchant for each of one or more assets of the merchant. Each of the assets includes a respective value in an associated currency. At step 204, the method includes receiving from the merchant, an allocation specification defining a division of payments to the merchant among the one or more assets. At step 206, the method includes receiving an order from the merchant, wherein the order defines a transaction value in a fiat currency. At step 208, the method includes dividing the transaction value into a plurality of allocations based on the allocation specification. At step 210, the method includes determining a conversion rate between the fiat currency and the currency of the asset associated with the allocation for each of the allocations. At step 212, the method includes converting each of the allocations from the fiat currency to the currency of the asset associated with the allocation based on the conversion rate. At step 214, the method includes notifying the merchant of the value of each allocation in the currency of the asset associated with the corresponding allocation.

In an illustrative embodiment, the method may include transmitting the transaction value from the merchant to a payment service in one or more electronic currencies referenced to the fiat currency and receive from the payment service to the merchant the value of each allocation in the currency of the asset associated with the corresponding allocation in response to receiving the transaction value, for example.

Converting each of the allocations from the fiat currency to the currency of the asset associated with the allocation in the apparatus may include computing a volume weighted average price of the currency of the asset across a plurality of public exchanges of the currency of the asset, for example. The volume weighted average price may be based on visible market liquidity of the currency of the asset, for example.

In another illustrative embodiment, converting each of the allocations from the fiat currency to the currency of the asset associated with the allocation in the apparatus may include querying a current price in the currency of the asset versus the fiat currency on both sides of a plurality of currency exchanges and determining liquidity of the currency of the asset on a plurality of currency exchanges. The currency exchanges can be centralized exchanges, for example, which may be hosted by a single entity in which users can join together to facilitate an exchange process. Alternatively, the currency exchanges may be decentralized wherein the exchange process may be facilitated by a decentralized technology protocol, for example.

### Example 1

In an exemplary embodiment of the disclosed system and method, a Merchant Gateway enables merchants to process sales orders accepting cryptocurrency assets visa customer payment methods and wallets. Serving as a standalone system for cryptocurrency payments, the merchant gateway can accompany and integrate with a conventional Point of Sale or eCommerce payment checkout system. This is facilitated via mechanisms outlined in this document.

According to an aspect of the present disclosure, a “Merchant Gateway” or “Gateway” may be implemented as a software product with payment functionality that allows merchants to accept payment in cryptocurrencies from customers.

In the exemplary implementation of the disclosed system and method, upon order checkout with a determined fiat (USD) price, the system applies price conversion to display an equivalent crypto currency market price, based on current open market liquidity on a crypto currency exchange such as the Bittrex crypto currency exchange. A checkout system user interface (UI) then displays payment instructions, either automatically or via manual action (e.g., merchant selects “Pay Now”), for the customer to make payment via:

QR code to scan from a supported mobile wallet;

Payment Address to manually send payment from a supported desktop or mobile wallet; and/or

Payment Username merchant payment destination to select.

Upon payment instructions display, the customer has a temporary payment time interval during which the price remains valid.

In the exemplary embodiment, within the cryptocurrency point of sale system, the payment time interval is a fixed time such as three minutes. The exemplary embodiment automatically recalculates a new cryptocurrency market price upon expiration. Merchants may set their own payment time interval via the Gateway API or choose not to have one, whereby cryptocurrency price, established during order checkout, remains permanently valid until the order is paid or cancelled. Payment will still be processed should a customer send it after the payment time interval expires. It just may not reflect the correct cryptocurrency market price anymore, relative to the fiat price for the order, since cryptocurrency price fluctuates on the open market. In this case, the system cannot automatically notify customer that the price is incorrect. The merchant's UI or business process must be designed to prevent this. Otherwise, the customer may send another payment for any balance owed and/or the merchant may refund any balance overpaid.

Upon display of payment instructions during order checkout, a permanent and unique payment address is generated for each new transaction. Customer payment initiates cryptocurrency asset custody temporarily moving to a cryptocurrency platform internal wallet. A unique Sale ID is then instantly created for the order, followed by immediately moving cryptocurrency custody to merchant's external wallet address on file in the system. Intermediary asset custody, which is handled by Gateway API, allows the platform to closely manage sales orders and payment activity. Creating the Sale ID ensures order fulfillment and provides order management benefits including payment tracking, by matching payments to orders via connection between the system and block-chain activity, a unique Sale ID point of reference allows order reconciliation flexibility, assessing balance owed for partial order balance payments, and ability to accept multiple payments to fulfill a single order.

Customers may acquire other cryptocurrency assets by purchasing them on crypto exchanges that provide a market for them. Upon crypto asset purchase, it is recommended to move (send) it from the exchange wallet to any dedicated wallet that supports the asset, both for the purposes of higher security and efficiency making payments from that wallet.

Cryptocurrency may be purchased on cryptocurrency exchanges and stored in the Waves Platform desktop wallet or iOS & Android mobile wallets, or in a cryptocurrency platform mobile wallet, for example. Customers do not need to fund or pre-pay an account with the merchant (liability for merchant).

Merchants may integrate Merchant Gateway functionality into their existing Point of Sale systems and eCommerce stores to begin accepting customer payments in cryptocurrency. Technical implementation required via Gateway API integration, for which the disclosed cryptocurrency platform may provide partial or complete development and UX/UI support, as needed.

What is claimed is:

1. A method of settling a payment transaction between a customer and a merchant via a payment service, the method comprising:
receiving by the payment service from a merchant, a respective identification of a merchant external wallet address for each of one or more assets of the merchant, wherein each of the assets comprises a respective value in an associated currency;
receiving by the payment service from the merchant, an allocation specification defining a division of payments to the merchant among the one or more assets;
receiving by the payment service an order from the merchant, the order defining a transaction value in a fiat currency;
dividing the transaction value into a plurality of allocations based on the allocation specification;
for each of the allocations, determining a conversion rate between the fiat currency and the currency of the asset associated with the allocation;
converting each of the allocations from the fiat currency to the currency of the asset associated with the allocation, based on the conversion rate;
notifying the merchant of the value of each allocation in the currency of the asset associated with the corresponding allocation.

2. The method of claim 1, further comprising:
receiving the transaction value from the merchant in the fiat currency;
in response to receiving the transaction value, providing to the merchant the value of each allocation in the currency of the asset associated with the corresponding allocation.

3. The method of claim 1, wherein converting each of the allocations from the fiat currency to the currency of the asset associated with the allocation comprises:
computing a volume weighted average price of the currency of the asset across a plurality of public exchanges of the currency of the asset.

4. The method of claim 3, wherein the volume weighted average price is based on visible market liquidity of the currency of the asset.

5. The method of claim 1, wherein converting each of the allocations from the fiat currency to the currency of the asset associated with the allocation comprises: querying a current price in the currency of the asset versus the fiat currency on both sides of a plurality of currency exchanges.

6. The method of claim 1, wherein converting each of the allocations from the fiat currency to the currency of the asset associated with the allocation comprises: determining liquidity of the currency of the asset on a plurality of currency exchanges.

7. An apparatus for settling a point of sale transaction involving a plurality of currencies between a customer and a merchant, the apparatus comprising:
a mobile device comprising a processor in communication with a memory and in communication with a user interface;
a trade engine module in the memory and executable by the processor, the trade engine module configured to:
receive from the merchant, a respective identification of a merchant external wallet address for each of one or more assets of the merchant, wherein each of the assets comprises a respective value in an associated currency;
receive from the merchant, an allocation specification on defining a division of payments to the merchant among the one or more assets;
receive an order from the merchant, the order defining a transaction value in a fiat currency;
divide the transaction value into a plurality of allocations based on the allocation specification;
for each of the allocations, determine a conversion rate between the fiat currency and the currency of the asset associated with the allocation;
convert each of the allocations from the fiat currency to the currency of the asset associated with the allocation, based on the conversion rate; and
notify the merchant of the value of each allocation in the currency of the asset associated with the corresponding allocation.

8. The apparatus of claim 7, wherein the trade engine is further configured to:
transmit the transaction value from the merchant to a payment service in one or more electronic currencies referenced to the fiat currency; and
in response to receiving the transaction value, receive from the payment service to the merchant the value of each allocation in the currency of the asset associated with the corresponding allocation.

9. The apparatus of claim 7, wherein converting each of the allocations from the fiat currency to the currency of the asset associated with the allocation comprises:
computing a volume weighted average price of the currency of the asset across a plurality of public exchanges of the currency of the asset.

10. The apparatus of claim 9, wherein the volume weighted average price is based on visible market liquidity of the currency of the asset.

11. The apparatus of claim 7, wherein converting each of the allocations from the fiat currency to the currency of the asset associated with the allocation comprises:
querying a current price in the currency of the asset versus the fiat currency on both sides of a plurality of currency exchanges.

12. The apparatus of claim 7, wherein converting each of the allocations from the fiat currency to the currency of the asset associated with the allocation comprises: determining liquidity of the currency of the asset on a plurality of currency exchanges.
